(19) United States
(12) Patent Application Publication
(10) Pub. No.: US 2004/0209537 A1
(43) Pub. Date: Oct. 21, 2004

(54) Functional high-strength adhesive sheet, manufacturing system and method thereof, and functional high-strength steel plate attached with the adhesive sheet

(76) Inventor: Sung-Man Jung, Suncheon-si (KR)

Correspondence Address: CHA & REITER, LLC, 210 ROUTE 4 EAST STE 103, PARAMUS, NJ, 07652, US

(21) Appl. No.: 10/606,978

(22) Filed: Jun. 26, 2003

(30) Foreign Application Priority Data
Apr. 15, 2003 (KR) 10-2003-0023780

(51) Int. Cl. B32B 5/12; B32B 15/04; B32B 27/12; B32B 31/00

(52) U.S. Cl. 442/58; 428/343; 442/149; 428/354; 442/64; 442/65; 442/394; 442/395; 442/398; 156/244.11; 156/273.3; 156/324

(57) ABSTRACT

Disclosed are a functional high-strength adhesive sheet using a nonwoven fabric, which is widely applied, a system and a method for manufacturing the adhesive sheet, and a functional high-strength steel plate attached with the adhesive sheet. The functional high-strength adhesive sheet comprises a polyethylene layer, a nonwoven fabric in which the polyethylene is pressed to its one surface, and a functional polyethylene layer pressed to the other surface of the nonwoven fabric. The functional high-strength adhesive sheet is manufactured by the method comprising: the steps of preheating the nonwoven fabric in the system; supplying and pressing a polyethylene on one surface of the preheated nonwoven fabric; uniformly distributing the polyethylene pressed on the nonwoven fabric, thus forming a polyethylene layer; drawing and transferring a preliminary sheet provided with the nonwoven fabric and the polyethylene layer pressed thereon, and winding the preliminary sheet on a winding roller; preheating the preliminary sheet; supplying and pressing a functional polyethylene on the other surface of the preheated preliminary sheet; uniformly distributing the functional polyethylene pressed on the preliminary sheet, thus forming a functional polyethylene layer; and drawing and transferring an adhesive sheet provided with the preliminary sheet and the functional polyethylene layer pressed thereon, and winding the adhesive sheet on the winding roller.

### CLAIM OF PRIORITY

This application makes reference to and claims all benefits accruing under 35 U.S.C. Section 119 from an application entitled “FUNCTIONAL HIGH-STRENGTH ADHESIVE SHEET, MANUFACTURING SYSTEM AND METHOD THEREOF, AND FUNCTIONAL HIGH-STRENGTH STEEL PLATE ATTACHED WITH THE ADHESIVE SHEET,” filed in the Korean Industrial Property Office on Apr. 15, 2003 and there duly assigned Serial No. 10-2003-0023780.

### BACKGROUND OF THE INVENTION

1. Field of the Invention

The present invention relates to a functional high-strength adhesive sheet, and more particularly to a functional high-strength adhesive sheet using a nonwoven fabric which is widely applied. Further, the present invention relates to a system and a method for manufacturing the adhesive sheet and a functional high-strength steel plate attached with the adhesive sheet.

2. Description of the Related Art

Generally, various kinds of adhesive sheets have been widely used in many industrial fields. Such adhesive sheets serve to improve the strength and corrosion resistance of an object attached with the adhesive sheets. Most of the conventional adhesive sheets are made of a general polyethylene resin.

However, the above conventional adhesive sheets have several problems. That is, the conventional adhesive sheets are made of a general polyethylene, or attached or pressed to another adhesive sheet, thus being low in their strength. Further, since the conventional adhesive sheets are not functional, they cannot be efficiently applied to various industrial fields.

Moreover, since the conventional adhesive sheets are weak in their self-strength, it is difficult to attach the sheets to other objects or to stack the sheets, and the sheets are easily damaged or broken in the attachment and stacking of the sheets.

### SUMMARY OF THE INVENTION

Therefore, the present invention has been made in view of the above problems, and it is an object of the present invention to provide a functional high-strength adhesive sheet, which is widely applied.

It is a further object of the present invention to provide a functional high-strength adhesive sheet, which is easily attached to other objects or stacked, and improves an operating efficiency in the attachment and stacking process.

It is another object of the present invention to provide a method for manufacturing a functional high-strength adhesive sheet, which withstands external impacts, has excellent endurance, and is widely applied.

It is yet another object of the present invention to provide a steel plate attached with a functional high-strength adhesive sheet.

In accordance with one aspect of the present invention, the above and other objects can be accomplished by the provision of a functional high-strength adhesive sheet comprising: a polyethylene layer; a nonwoven fabric in which the polyethylene is pressed to its one surface; and a functional polyethylene layer pressed to the other surface of the nonwoven fabric.

In accordance with a further aspect of the present invention, there is provided a system for manufacturing a functional high-strength adhesive sheet comprising: feeding means including a roller for feeding a nonwoven fabric or a preliminary sheet formed by pressing a polyethylene to the nonwoven fabric, an unwinding roller for unwinding the nonwoven fabric or the preliminary sheet from the roller, and pressure rollers and an idle roller for maintaining a proper tensile strength of the nonwoven fabric or the preliminary sheet; preheating means for preheating the nonwoven fabric or the preliminary sheet fed from the feed means; feeding means for feeding a polyethylene or a functional polyethylene, including a hopper for storing the polyethylene or the functional polyethylene to be fed to the preheated nonwoven fabric or preliminary sheet, an extractor for discharging the polyethylene or the functional polyethylene from the hopper, and a die for supplying the polyethylene or the functional polyethylene discharged from the extractor to the nonwoven fabric or the preliminary sheet; pressing means including a pressure roller and a chill roller for pressing the polyethylene or the functional polyethylene to the nonwoven fabric or the preliminary sheet; forming means for forming a polyethylene layer or a functional polyethylene layer, including a stripper roll and a slitter for uniformly distributing the polyethylene pressed on the preliminary sheet or the functional polyethylene pressed on an adhesive sheet; and winding means including driving rollers and a winding roller for drawing, transferring and winding the preliminary sheet or the adhesive sheet.

In accordance with another aspect of the present invention, there is provided a method for manufacturing a functional high-strength adhesive sheet comprising the steps of: (a) supplying a nonwoven fabric wound on a roller to a preheating drum via an unwinding roller, pressure rollers and an idle roller so that the nonwoven fabric is preheated by the preheating drum; (b) supplying the preheated nonwoven fabric to a gap between a pressure roller and a chill roller; (c) supplying a polyethylene on one surface of the nonwoven fabric supplied between the pressure roller and the chill roller, and then pressing the polyethylene on the nonwoven fabric; (d) uniformly distributing the polyethylene pressed on the nonwoven fabric, thus forming a polyethylene layer; (e) drawing and transferring a preliminary sheet provided with the nonwoven fabric and the polyethylene layer pressed thereon, and winding the preliminary sheet on a winding roller; (f) replacing the roller with the winding roller, supplying the preliminary sheet wound on the winding roller to the preheating drum via the unwinding roller, the pressure rollers and the idle roller so that the preliminary sheet is preheated by the preheating drum; (g) supplying the preheated preliminary sheet to the gap between the pressure roller and the chill roller; (h) supplying a functional polyethylene on the other surface of the preliminary sheet supplied between the pressure roller and the chill roller, and then pressing the functional polyethylene on the preliminary sheet; (i) uniformly distributing the functional polyethylene pressed on the preliminary sheet, thus forming a functional polyethylene layer; and (j) drawing and transferring an adhesive sheet provided with the preliminary sheet and the functional polyethylene layer pressed thereon, and winding the adhesive sheet on the winding roller.

In accordance with yet another aspect of the present invention, there is provided a functional high-strength steel plate with excellent corrosion resistance and abrasion resistance, manufactured by attaching a functional high-strength adhesive sheet to a steel plate using a high-frequency welding method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partially enlarged view illustrating the structure of a functional high-strength adhesive sheet in accordance with the present invention;

FIG. 2 is a schematic view illustrating a process for manufacturing a polyethylene compound for manufacturing the functional high-strength adhesive sheet in accordance with the present invention;

FIGS. 3a and 3b are flow charts illustrating a system and a method for manufacturing the functional high-strength adhesive sheet in accordance with the present invention; and

FIG. 4 is a flow chart illustrating a process for manufacturing a functional high-strength steel plate attached with the adhesive sheet in accordance with the present invention.

### DESCRIPTION OF THE PREFERRED EMBODIMENTS

Now, preferred embodiments of the present invention will be described in detail with reference to the annexed drawings.

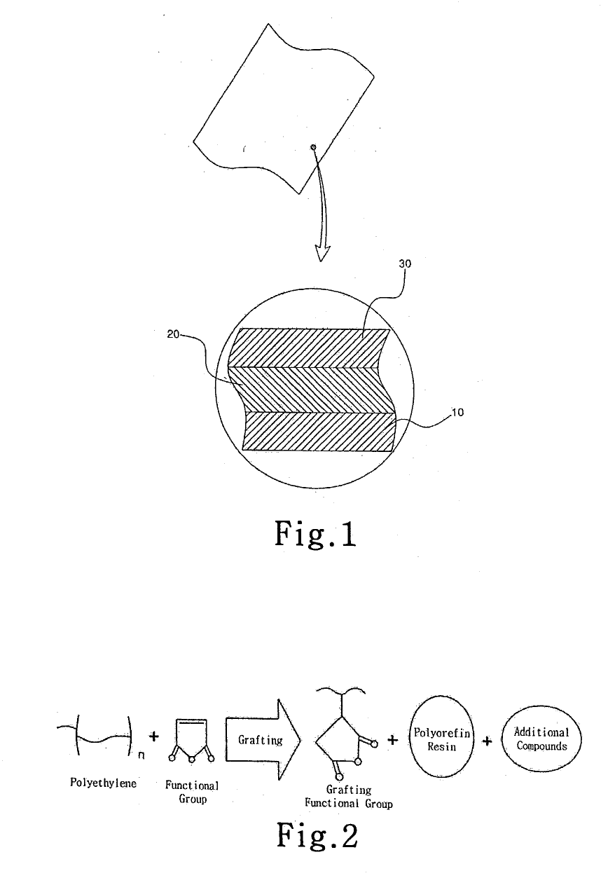

With reference to FIG. 1, a functional high-strength adhesive sheet in accordance with the present invention generally comprises a polyethylene layer 10. Since the polyethylene layer 10 can be manufactured or prepared by various methods, a detailed description thereof will thus be omitted because it is considered to be well known to persons skilled in the art.

The polyethylene layer 10 is attached or pressed to one surface of a nonwoven fabric 20. Preferably, the nonwoven fabric 20 is a gauze-type natural nonwoven fabric with various structures or shapes. A leading factor to be considered in selecting the nonwoven fabric 20 is a weight per square meter of the nonwoven fabric 20. The large weight per square meter of the nonwoven fabric denotes a large thickness of cross stripes of the nonwoven fabric. As the weight per square meter of the nonwoven fabric increased, the strength of the nonwoven fabric also increases, but it is difficult to laminate the nonwoven fabric. On the other hand, as the weight per square meter of the nonwoven fabric decreases, it is easy to laminate the nonwoven fabric, but the strength of the nonwoven fabric also decreases. As a result of a test, it was established that the nonwoven fabric has a proper strength and is easily laminated when the weight per square meter of the nonwoven fabric is about 40 g. Preferably, the nonwoven fabric 20 is selected from either HS cord 560312 or 560392 out of HS cord 560300 series.

A functional polyethylene layer 30 is attached or pressed to the other surface of the nonwoven fabric 20. As shown in FIG. 2, in order to manufacture the functional polyethylene layer 30, a functional polyethylene compound is used. Preferably, such a functional polyethylene compound is manufactured by preparing a pure polyethylene, providing a functional group to the polyethylene, grafting the functional group to the polyethylene, and adding a polyolefin resin and additional compounds to the polyethylene with the functional group.

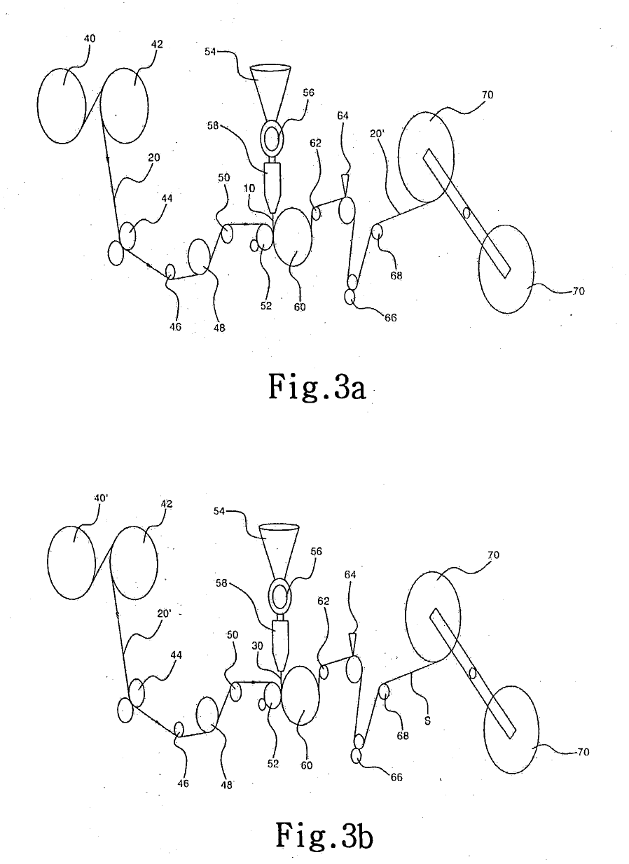

The above-described functional high-strength adhesive sheet is manufactured by a process shown in FIGS. 3a and 3b.

First, a system for manufacturing a functional high-strength adhesive sheet shown in FIGS. 3a and 3b is schematically described, as follows. The above sheet manufacturing system comprises a roller 40 for providing the nonwoven fabric 20 or a preliminary adhesive sheet 20′, and an unwinding roller 42 for unwinding the nonwoven fabric 20 or the preliminary adhesive sheet 20′ wound on the roller. Pressure rollers 44 and an idle roller 46 for maintaining a proper tensile strength of the nonwoven fabric 20 or the preliminary adhesive sheet 20′ fed from the unwinding roller 42 are installed in sequence. Then, a preheating drum 48 for preheating the nonwoven fabric 20 or the preliminary adhesive sheet 20′ is installed. After that, an idle roller 50 and a pressure roller 52 are installed.

There are installed a hopper 54 for providing a general polyethylene or a functional polyethylene to the transferring nonwoven fabric 20 or preliminary adhesive sheet 20′, an extractor 56 for discharging the general polyethylene or functional polyethylene from the hopper 54, and a die 58 for providing the general polyethylene or functional polyethylene from the extractor 56 to the nonwoven fabric 20 or preliminary adhesive sheet 20′. A chill roller 62 for pressing the general polyethylene or functional polyethylene to the nonwoven fabric 20 or preliminary adhesive sheet 20′ is located so as to contact the pressure roller 52.

There are installed a stripper roll 62 and a slitter 64, for uniformly distributing the general or functional polyethylene pressed to the nonwoven fabric 20 or preliminary adhesive sheet 20′ fed from the chill roller 60, and simultaneously for forming the polyethylene layer 10 or the functional polyethylene layer 30 by removing the excessive amount of the general or functional polyethylene. Subsequently, there are continuously installed driving rollers 66 and an idle roller 68 for drawing and moving the preliminary sheet or adhesive sheet. Finally, there is installed winding rollers 70 for winding the manufactured preliminary sheet or functional adhesive sheet. Here, the winding rollers 70 are replaceable.

Hereinafter, a method for manufacturing a functional high-strength adhesive sheet of the present invention using the above-configured manufacturing system is described in detail.

First, a worker connects the nonwoven fabric 20 from the roller 40, on which the nonwoven fabric 20 is wound, to the unwinding roller 42, and then operates the system. Then, the nonwoven fabric 20 unwound from the unwinding roller 42 with a proper tensile strength is fed to the preheating drum 48 via the pressure rollers 44 and the idle roller 46, and then preheated by the preheating drum 48. The nonwoven fabric 20 is fed into a gap between the pressure roller 52 and the chill roller 60 via the idle roller 50.

Here, a general polyethylene provided into the hopper 54 passes through the extractor 56 and is fed onto one surface of the nonwoven fabric 20 via the die 58. The fed polyethylene is pressed to the nonwoven fabric 20 by means of the pressure roller 52 and the chill roller 60.

The nonwoven fabric 20 attached with the polyethylene, i.e., a preliminary sheet 20′, is provided from the chill roller 60 to the stripper roll 62 and the slitter 64 so that the polyethylene on the nonwoven fabric 20 is uniformly distributed and the excessive amount of the polyethylene is removed. Thereby, the polyethylene layer 10 is formed on one surface of the nonwoven fabric 20.

Finally, the preliminary sheet 20′ passes through the driving rollers 66 and the idle roller 68, and is fed to the winding roller 70 so that the preliminary sheet 20′ is wound on the winding roller 70.

After the formation of the preliminary sheet 20′ is completed, the roller 40 is replaced with the winding roller 70 wound with the preliminary sheet 20′. Hereinafter, the winding roller 70 as a substitute of the roller 40 is referred to as a roller 40′. In the same manner of forming the preliminary sheet 20′ provided with the polyethylene layer 10 at its one surface, an adhesive sheet is manufactured. That is, the worker connects the preliminary sheet 20′ from the roller 40′, on which the preliminary sheet 20′ is wound, to the unwinding roller 42, and then operates the system. Then, the preliminary sheet 20′ unwound from the unwinding roller 42 with a proper tensile strength is fed to the preheating drum 48 via the pressure rollers 44 and the idle roller 46, and preheated by the preheating drum 48. The preliminary sheet 20′ is fed into a gap between the pressure roller 52 and the chill roller 60 via the idle roller 50.

Here, a functional polyethylene provided into the hopper 54 passes through the extractor 56 and is fed onto the other surface of the preliminary sheet 20′ via the die 58. The fed functional polyethylene is pressed to the preliminary sheet 20′ by means of the pressure roller 52 and the chill roller 60.

The preliminary sheet 20′ attached with the functional polyethylene, i.e., an adhesive sheet (S), is provided from the chill roller 60 to the stripper roll 62 and the slitter 64 so that the functional polyethylene on the nonwoven fabric 20 is uniformly distributed and the excessive amount of the functional polyethylene is removed. Thereby, the functional polyethylene layer 30 is formed on the other surface of the nonwoven fabric 20.

Finally, the functional high-strength adhesive sheet (S) passes through the driving rollers 66 and the idle roller 68, and is fed to the winding roller 70 so that the adhesive sheet (S) is wound on the winding roller 70. Thereby, the functional high-strength adhesive sheet (S) as shown in FIG. 1 is manufactured.

In accordance with another embodiment of the present invention, a functional high-strength steel plate is manufactured by attaching the above-described functional high-strength adhesive sheet to a steel plate.

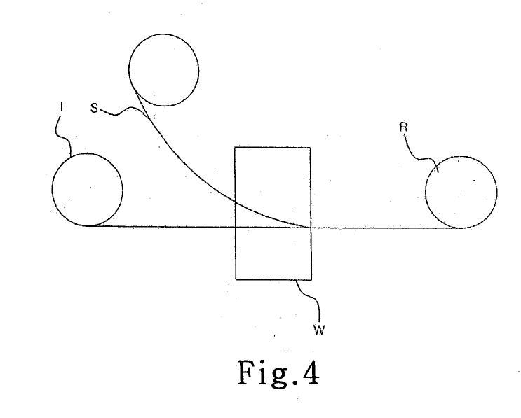

That is, as shown in FIG. 4, a pure steel plate (I) wound on a roll is unwound from the roll, and a functional high-strength adhesive sheet (S) wound on another roll is unwound from the toll. The unwound steel plate (I) and adhesive sheet (S) are welded in a high-frequency induction heater (W), and then wound on a roller (R), thus being formed as a functional high-strength steel plate. Here, since the functional high-strength adhesive sheet is employed, it is possible to manufacture the functional high-strength steel plate with a uniform thickness at high speed.

As apparent from the above description the present invention provides a functional high-strength adhesive sheet, which is rapidly and easily manufactured by operating the same manufacturing system two times. Further, there is provided a functional high-strength adhesive steel plate, which is manufactured using the adhesive sheet.

In accordance with the present invention, it is possible to improve the strength of the functional high-strength adhesive sheet by attaching a functional polyethylene to a nonwoven fabric by pressing, thus improving the quality of a product and broadening the application of the product.

Further, the functional high-strength adhesive sheet is easily manufactured by repeatedly operating the same manufacturing system two times, thus improving the operating efficiency of the system.

Moreover, since the functional high-strength adhesive sheet is attached to a steel plate at high speed, without the variation of the thickness of the adhesive sheet, by a high-frequency induction heating method, the functional high-strength adhesive steel plate can be easily manufactured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A functional high-strength adhesive sheet comprising:
a polyethylene layer;
a nonwoven fabric in which the polyethylene is pressed to its one surface; and
a functional polyethylene layer pressed to the other surface of the nonwoven fabric.

2. The functional high-strength adhesive sheet as set forth in claim 1,
wherein the nonwoven fabric has a weight of 25 g to 70 g per square meter.

3. The functional high-strength adhesive sheet as set forth in claim 1,
wherein the functional polyethylene layer is a polyethylene compound manufactured by providing a functional group to a pure polyethylene, grafting the provided functional group to the pure polyethylene, and adding a polyolefin resin and additional compounds to the resulted polyethylene.

4. A system for manufacturing a functional high-strength adhesive sheet comprising:
feeding means including a roller for feeding a nonwoven fabric or a preliminary sheet formed by pressing a polyethylene to the nonwoven fabric, an unwinding roller for unwinding the nonwoven fabric or the preliminary sheet from the roller, and pressure rollers and an idle roller for maintaining a proper tensile strength of the nonwoven fabric or the preliminary sheet;
preheating means for preheating the nonwoven fabric or the preliminary sheet fed from the feed means;
feeding means for feeding a polyethylene or a functional polyethylene, including a hopper for storing the polyethylene or the functional polyethylene to be fed to the preheated nonwoven fabric or preliminary sheet, an extractor for discharging the polyethylene or the functional polyethylene from the hopper, and a die for supplying the polyethylene or the functional polyethylene discharged from the extractor to the nonwoven fabric or the preliminary sheet;
pressing means including a pressure roller and a chill roller for pressing the polyethylene or the functional polyethylene to the nonwoven fabric or the preliminary sheet;
forming means for forming a polyethylene layer or a functional polyethylene layer, including a stripper roll and a slitter for uniformly distributing the polyethylene pressed on the preliminary sheet or the functional polyethylene pressed on an adhesive sheet; and
winding means including driving rollers and a winding roller for drawing, transferring and winding the preliminary sheet or the adhesive sheet.

5. A method for manufacturing a functional high-strength adhesive sheet comprising the steps of:
(a) supplying a nonwoven fabric wound on a roller to a preheating drum via an unwinding roller, pressure rollers and an idle roller so that the nonwoven fabric is preheated by the preheating drum;
(b) supplying the preheated nonwoven fabric to a gap between a pressure roller and a chill roller;
(c) supplying a polyethylene on one surface of the nonwoven fabric supplied between the pressure roller and the chill roller, and then pressing the polyethylene on the nonwoven fabric;
(d) uniformly distributing the polyethylene pressed on the nonwoven fabric, thus forming a polyethylene layer;
(e) drawing and transferring a preliminary sheet provided with the nonwoven fabric and the polyethylene layer pressed thereon, and winding the preliminary sheet on a winding roller;
(f) replacing the roller with the winding roller, supplying the preliminary sheet wound on the winding roller to the preheating drum via the unwinding roller, the pressure rollers and the idle roller so that the preliminary sheet is preheated by the preheating drum;
(g) supplying the preheated preliminary sheet to the gap between the pressure roller and the chill roller;
(h) supplying a functional polyethylene on the other surface of the preliminary sheet supplied between the pressure roller and the chill roller, and then pressing the functional polyethylene on the preliminary sheet;
(i) uniformly distributing the functional polyethylene pressed on the preliminary sheet, thus forming a functional polyethylene layer; and
(j) drawing and transferring an adhesive sheet provided with the preliminary sheet and the functional polyethylene layer pressed thereon, and winding the adhesive sheet on the winding roller.

6. A functional high-strength steel plate manufactured by attaching to a steel plate using a high-frequency welding method a functional high-strength adhesive sheet comprising a polyethylene layer, a nonwoven fabric in which the polyethylene is pressed to its one surface, and a functional polyethylene layer pressed to the other surface of the nonwoven fabric.
